(19) United States
(12) Patent Application Publication
(10) Pub. No.: US 2019/0168470 A1
(43) Pub. Date: Jun. 6, 2019

(54) Currency Operated Tire Inflation and Repair Apparatus and Methods

(71) Applicant: Consumer Products International LLC., Wilder, ID (US)

(72) Inventors: Robert W. Paasch, Wilder, ID (US); Ray Gross, Wilder, ID (US)

(73) Assignee: Consumer Products International LLC., Wilder, ID (US)

(21) Appl. No.: 16/326,026

(22) PCT Filed: Aug. 15, 2017
(86) PCT No.: PCT/US2017/047003

§ 371 Date: Feb. 15, 2019

Related U.S. Application Data
(60) Provisional application No. 62/375,392, filed on Aug. 15, 2016.

(51) Int. Cl. B29C 73/16; B60S 5/04

(52) U.S. Cl. CPC B29C 73/166; B60S 5/046

(57) ABSTRACT

The present disclosure provides tire pressurization/sealant systems that can include a coned plunger valve. The present disclosure also provides tire pressurization/sealant systems that can include, for example, a first fluid source, a plunger valve assembly, a first conduit extending from the first fluid source to the plunger valve assembly, and a tire pressurizing hose extending from the plunger valve assembly. The present disclosure also provides methods for providing sealant to a tire via a tire pressurizing hose and cleaning out the tire pressurizing hose. The methods can include providing tire sealant to a tire via a tire pressuring hose through a plunger valve assembly and reconfiguring the plunger valve assembly to provide an aqueous solution through the hose to clean out the valve assembly and the hose.

### CLAIM FOR PRIORITY

This application claims priority to U.S. provisional patent application Ser. No. 62/375,392 filed Aug. 15, 2016, entitled “Currency Operated Tire Inflation and Repair Apparatus and Methods” the entirety of which is hereby incorporated by reference.

### TECHNICAL FIELD

The present disclosure relates to tire inflation repair assemblies and methods, and in particular embodiments, currency operated fluid addition and tire repair assemblies and methods.

### BACKGROUND

Fluids that may be added to tires to repair leaks in tires are currently available. The present disclosure addresses the problem of providing these fluids at remote locations at a cost to the consumer, thereby alleviating the need for the consumer to store these fluids in a vehicle. The storage of these fluids can be difficult because the consumer is required to periodically exchange the fluids for other fluids that may be newer or fresher fluids. The present disclosure provides currency operated assemblies and methods for providing these fluids. The preparation of these assemblies and methods can be difficult for at least the reason that the fluids have a tendency to clog conduits that they may in for extended periods of time. Embodiments of the present disclosure provide methods and assemblies that overcome these problems.

### SUMMARY

The present disclosure provides systems and methods for the currency operated filling and sealing of vehicle tires.

Methods for repairing tires are also provided with the methods including providing tire sealant to a tire from a tire repair assembly upon depositing currency in the tire repair assembly.

Stand alone currency operated tire repair assemblies are also provided with the assemblies including: a tire sealant tank; an air compressor operatively coupled to the tank; a valve operatively aligned between the tank and the air compressor; a flow meter operatively aligned between the tank and the air compressor; and computer processing circuitry operatively coupled to the air compressor, the valve, and the flow meter.

The present disclosure provides tire pressurization/sealant systems that can include a coned plunger valve. The present disclosure also provides tire pressurization/sealant systems that can include, for example, a first fluid source, a plunger valve assembly, a first conduit extending from the first fluid source to the plunger valve assembly, and a tire pressurizing hose extending from the plunger valve assembly. The present disclosure also provides methods for providing sealant to a tire via a tire pressurizing hose and cleaning out the tire pressurizing hose. The methods can include providing tire sealant to a tire via a tire pressuring hose through a plunger valve assembly and reconfiguring the plunger valve assembly to provide an aqueous solution through the hose to clean out the valve assembly and the hose.

### BRIEF DESCRIPTION OF THE DRAWINGS

Embodiments of the disclosure are described below with reference to the following accompanying drawings.

FIG. 1 is an assembly according to an embodiment of the disclosure.

FIG. 2 is an assembly according to another embodiment of the disclosure.

FIG. 3 is an operational schematic for use with the assembly of FIGS. 1 and/or 2 according to an embodiment.

FIG. 4 is a depiction of a valve assembly having a coned plunger configured to connect and disconnect sealant from the air supply conduit.

### DESCRIPTION

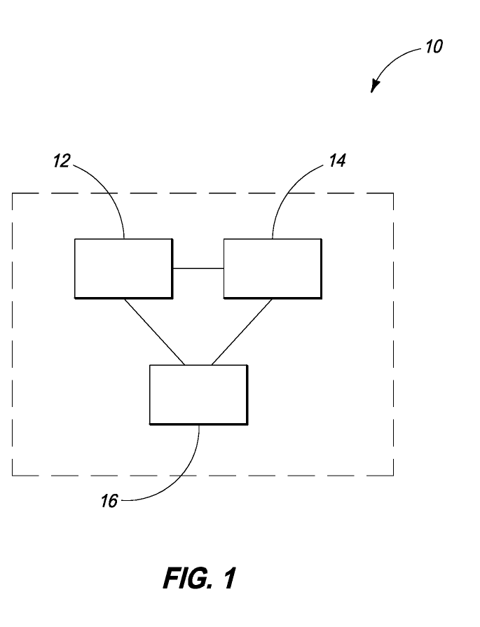

The assemblies and methods of the present disclosure will be described with reference to FIGS. 1-4. Referring first to FIG. 1, an assembly 10 is shown that includes an air consolidation assembly 12. Air consolidation assembly 12 can be a motorized compressor, for example. It can also be a pressurized tank of air. The air that may be utilized may be pure oxygen, or air itself which is a mixture of oxygen, nitrogen, and carbon dioxide, for example. It may also be nitrogen, for example. This air supply 12 may be coupled to a valve assembly 16. Valve assembly 16 may be a solenoid valve that can be operated through mechanical and/or electrical means, for example. In accordance with example configurations, a mechanically operated solenoid valve may provide air from assembly 12 to fluid storage assembly 14. Fluid storage assembly 14 may be a tank or other container that may be constructed of, for example, metal or an inert plastic such as a polypropylene or polystyrene material. Fluid container 14 can contain a tire sealant, for example. The fluid can be, for example, liquid latex based, liquid rubber based, synthetic foaming agents and of varying viscus coagulating properties to seal punctures. Control of value 16 thereby providing air from assembly 12 through liquid container 14 can be manipulated through a user interface. The user interface may be mechanical and/or electrical. The user interface may be computer operated, for example, as well. The user interface may be configured to receive coins for operation or other currency, such as dollar bills. The user interface may also be configured to receive credit cards for operation as well. Upon initiation of the valve solenoid, air can be provided from air storage assembly 12 to fluid container 14, and fluid and air can be provided to a tire for re-inflation and/or repair, as desired. The tubing connecting air assembly 12 and the fluid assembly 14 as well as the tubing to the tire can be constructed of an inert material that does not facilitate the solidification of the sealant material in tank 14. In accordance with example configurations, the sequence of events can be started to facilitate the repair and/or filling of a tire. For example, upon initiation of operation of assembly 10, a slight amount of air can be added to the tire, and then the solenoid engaged to provide tire sealant to the tire, and then a desired amount of tire sealant or a predetermined amount of tire sealant is added followed by air being provided through the lines to the tire. In such a fashion, the lines exiting the assembly can be cleared of sealant for the next use.

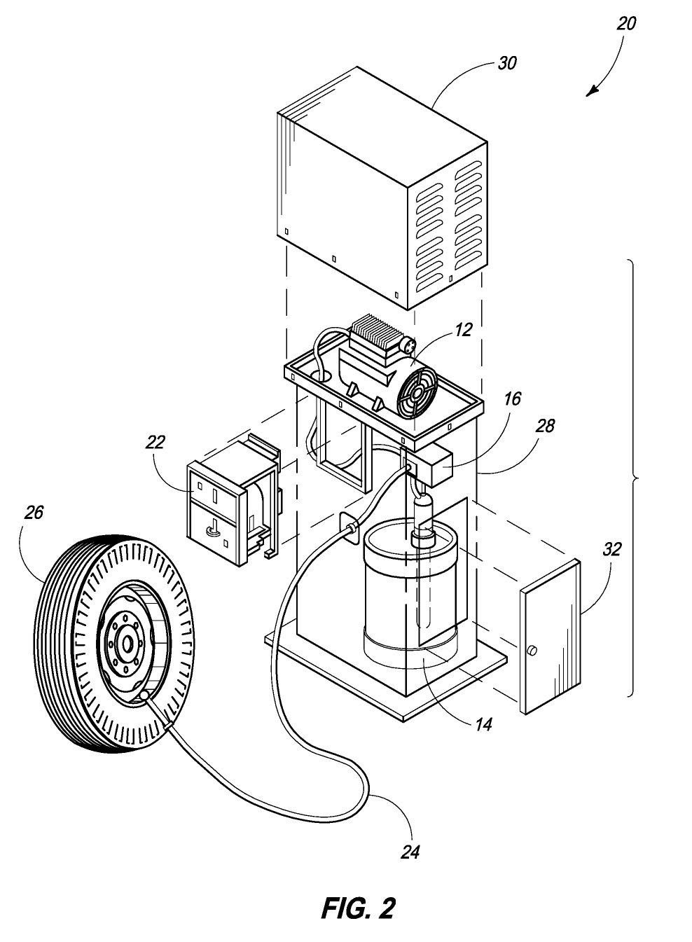

Referring to FIG. 2, an assembly 20 is provided according to another embodiment. In accordance with example configurations, assembly 20 includes air assembly 12 which, as shown here, is an air compressor. Assembly 20 can include valve assembly 16 as well as tank assembly 14. Assembly 20 can also include interface 22. As shown here, interface 22 can be a coin operated interface. Assembly 20 can include a top cover 30 as well as a door panel 32 that may be connected to a housing 28 that encompasses a substantial number of assemblies within assembly 20. Assembly 20 can also include line 24 such as a tire hose that may be utilized to extend to a tire 26 for inflation.

As can be seen from assembly 20, repair maintenance access can be provided to different components of assembly 20 by design. For example, cover 30 can be removed from assembly 20 to allow access to air assembly 12 for repair and maintenance. Also, door 32 can be coupled to housing 28 to allow for repair and maintenance and/or refilling of tank 14. According to example implementations, tank 14 can be a refillable tank that may not have hard side walls. It may be simply a bag with soft side walls that may be suspended in a tank. These tanks can have easy-clasp configurations or snap fits that allow for the quick release of the tank to the hardware of assembly 12. In accordance with example implementations, upon initiation of the repair and filling sequence, compressor 12 may be initiated for a few moments to build up sufficient pressure and air provided to tire 26, then at a predetermined time or desired time, valve 16 may be engaged to provide fluid from tank 14 through tubing 24 to tire 26. Upon a desired amount of time and/or an amount of fluid being provided to tire 26, a close down or cleaning sequence may be initiated, allowing for the removal of fluid from lines such as tire line 24.

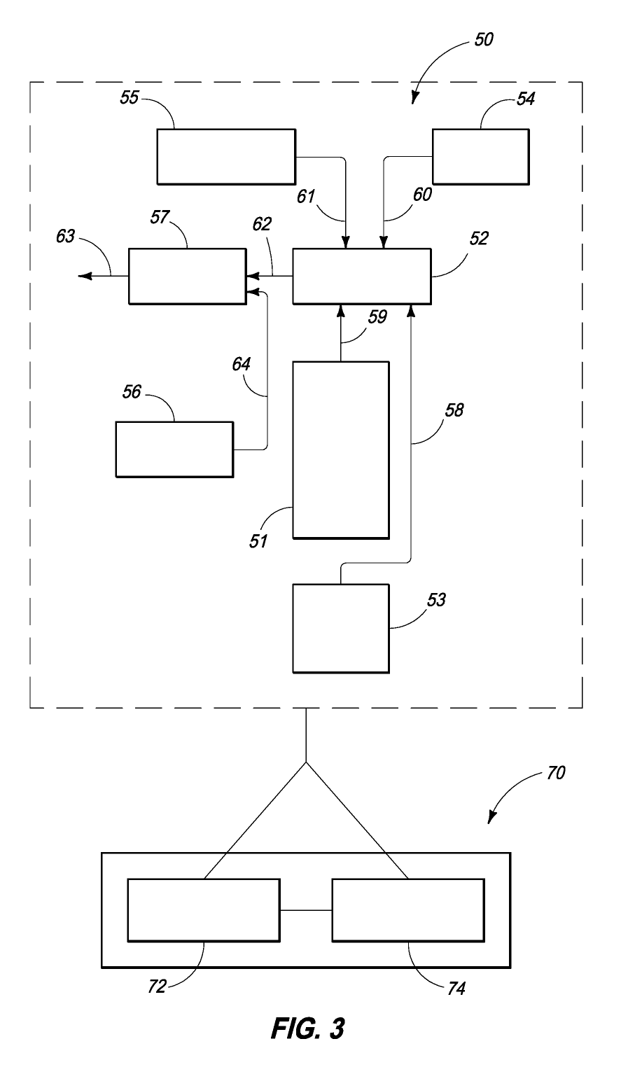

Referring to FIG. 3, tire repair assembly 50 can include a tire sealant tank 51. Tank 51 can be configured as a product storage tank and may include a proprietary filling unit that only accepts manufacture/operator designed interfaces to discourage other non-approved sealants from being utilized. Tank 51 can contain a suspension of flakes and fine fibers in a liquid, and/or a natural or synthetic liquid rubber; example materials include latex materials.

Air assembly 52 such as a pressure unit that can include an air compressor such as diaphragm pump, piston or screw pump and/or air pressure pump, can be coupled to the tire sealant tank 51 via pressure unit product connection 59. Connections such as connection 59 can be used to operatively couple components of assembly 52. In this case the operatively coupling is fluid communication. In accordance with example implementations fluid communication between these components as well as all components in the assembly can be controlled by one or a combination of valves and/or flow meters.

As indicated herein assembly 50 can include a currency operating assembly. This operating assembly may be mechanically and/or electronically coupled to the one or more valves and/or flow meters operatively aligned along the fluid communication between components. In one example, the mechanical coupling can engage/disengage the valves and/or flow meters.

In accordance with another implementation, assembly 50 can include computer processing circuitry 70. Circuitry 70 can be configured/used to control valves and/or flow meters of assembly 50 as well as record/control other components of assembly 50. Circuitry 70 can include processing circuitry 72 as well as storage circuitry 74. Circuitry 70 may have a user interface in the form of a wired or wireless interface for example. Example processing circuitry can include but is not limited to communications circuitry such as wireless communication devices, for example WiFi devices. Example communications circuitry can be a mini computer equipped with a WiFi connection.

Processing circuitry may comprise circuitry configured to implement desired programming provided by appropriate media in at least one embodiment. For example, processing circuitry may be implemented as one or more of a processor and/or other structure configured to execute executable instructions including, for example, software and/or firmware instructions, and/or hardware circuitry. Exemplary embodiments of processing circuitry include hardware logic, PGA, FPGA, ASIC, state machines, and/or other structures alone or in combination with a processor. These examples of processing circuitry are for illustration and other configurations are possible.

At least some embodiments or aspects described herein may be implemented using programming stored within appropriate processor-usable media and/or communicated via a network or other transmission media and configured to control appropriate processing circuitry. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet and/or a private network), wired electrical connection, optical connection and/or electromagnetic energy, for example, via a communications interface, or provided using other appropriate communication structure or medium. Example programming including processor-usable code may be communicated as a data signal embodied in a carrier wave in but one example.

Storage circuitry may be embodied in a number of different ways using electronic, magnetic, optical, electromagnetic, or other techniques for storing information. Some specific examples of storage circuitry include, but are not limited to, a portable magnetic computer diskette, such as a floppy diskette, zip disk, hard drive, random access memory, read only memory, flash memory, cache memory, and/or other configurations capable of storing programming, data, or other digital information. In one embodiment, storage circuitry may store programming implemented by the processing circuitry.

The user interface is configured to interact with a user including conveying data to a user (e.g., displaying data for observation by the user, audibly communicating data to a user, etc.) as well as receiving inputs from the user (e.g., tactile input, voice instruction, etc.). Accordingly, in one example embodiment, the user interface may include a display (e.g., cathode ray tube, LCD, etc.) configured to depict visual information and an audio system as well as a keyboard, mouse and/or other input device. This interface may be integrated with the currency assembly, for example. Any other suitable apparatus for interacting with a user may also be utilized.

The circuitry operatively coupled to one or more of the air assembly, the sealant tank, the currency operating assembly, and/or the valve. Via the interface, information such as one or more of sealant amount, currency received, and/or credit card information can be provided to remote computers.

Assembly 50 can also include a clean out assembly associated with the air assembly and the tire sealant container. Accordingly, pressure unit clean out assembly 56 can be coupled via pressure unit clean out connection 64 to flow meter 57 which can be operatively coupled to air assembly 52.

Assembly 50 can also include a temperature control assembly, such as temperature control 55, operatively coupled to the tire sealant tank 51 and/or conduits associated with same.

Flow meters such as flow meter 57 operatively coupled to the outlet of the tire sealant tank as well as assemblies 52 and 56.

Assembly 50 can also include a scale 53 that may be operatively engaged with tank 51 to acquire data relating to amount of sealant used/available. This data may be acquired/processed with circuitry 70. Scale 53 can include a volume sensor, and/or sealant levels may be monitored by weight float system, visual window, for example. Time flow controller 54 may be utilized to regulate flow of sealant and/or temperature control of assembly 50 thereby providing heat at night and/or cooling during the day.

Connections 58, 60, 61, 62, and/or 63 can be utilized to operatively connect the assemblies. The operative connection can include fluid conduit and electrical conduit for example.

Assemblies of the present disclosure may be provided as a stand alone unit, requiring only a power supply to operate or components of the assemblies can be provided to already existing units and the existing units reconfigured.

In accordance with the assemblies provided, methods for repairing tires can include providing tire sealant to a tire from a tire repair assembly upon depositing currency in the tire repair assembly. In accordance with an example aspect, after providing the sealant, flushing any remaining sealant from any conduits used to provide the sealant can be performed.

The tire sealant can be maintained in a fluid state by controlling the temperature, for example and this control may be performed according to a predetermined plan or as instructed remotely, for example. As another example of remote control, upon the providing sealant, processing circuitry can signal a remote computer processing system as to the status of the tire repair assembly. This can also be performed periodically and data can be exchanged between two systems, such data can include tire sealant amount available/used and/or currency received.

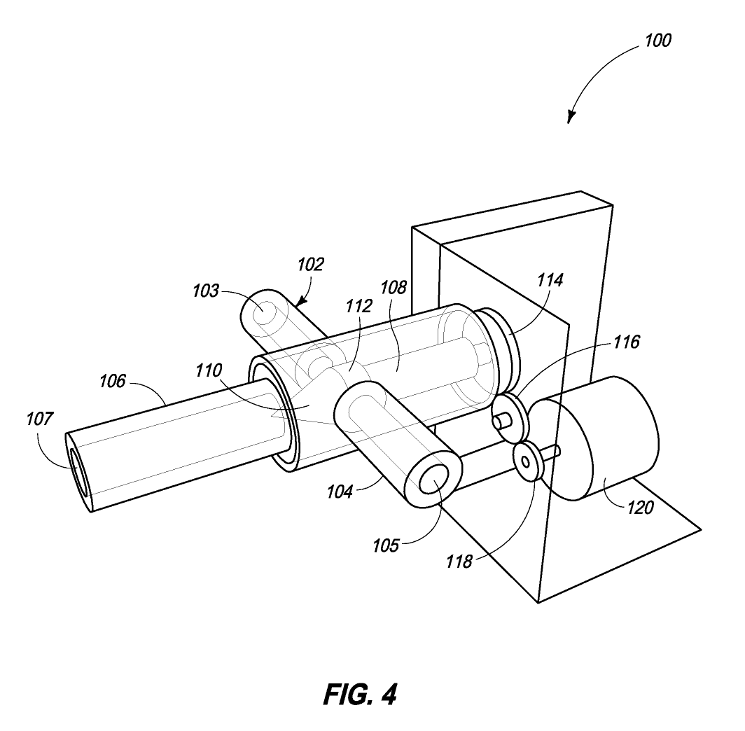

Referring next to FIG. 4, a valve assembly is depicted that can be utilized between the air supply and sealant supply according to an alternative embodiment of the disclosure. As can be seen, the three way connection includes a plunger driven valve assembly that can include a coned plunger. The plunger can be operatively connected to a motor to extend or withdraw the plunger, and the motor can be controlled by the processing circuitry. When fully extended the plunger stops sealant from proceeding.

Referring to FIG. 4, a valve assembly 100 is provided that can be configured as a plunger valve assembly. Valve assembly 100 can include at least two conduits, conduit 102 which is normal to conduit 106. Further provided are alternative embodiments that can include additional conduit 104 which opposes conduit 102. Each of these conduits can have internal diameters, respectively, 103, 105, and 107. In accordance with example implementations, the valve assembly can include a plunger 108 that can extend. Plunger 108 can include a gear end portion 114 which is mechanically associated with another gear portion 116 which is mechanically associated with an additional gear portion 118 which is connected to a motor 120. Motor 120 can be a reversible motor such as an electric motor, for example. This electric motor can be operatively coupled to the processing circuitry and power of the presently described entire tire sealant system. In operable situations, the plunger can be moved from a first position where cone portion 110 sealably engages conduit 106 while also sealing conduits 104 and 102 via a base portion 112. In accordance with example implementations, base portion 112 can have a height that is at least greater than the diameter of conduit openings 105 and/or 103, for example. In accordance with example implementations, one or more fluids can be provided to either of two of the three conduits or one of the two conduits, depending on the configuration. In one configuration, air sealant and/or clean out solution such as an aqueous solution can be provided to conduit 106, and conduit 102 can be coupled to a tire pressurization hose. In operating in this configuration, withdrawing the plunger can open conduit 106 to conduit 102. In closing, these can be closed as well. In accordance with other example implementations, more than one solution can be provided by having an additional solution provided via conduit 104.

In accordance with example implementations, the cone portion can be aligned with conduit 106 and in between opposing conduits 102 and 104.

1. A tire pressurization/sealant system that includes a coned plunger valve.

2. The tire pressurization/sealant system of claim 1 wherein the coned plunger valve is operatively aligned between two opposing conduits.

3. The tire pressurization/sealant system of claim 1 wherein the coned plunger valve is operatively aligned at the intersection of two normally aligned conduits.

4. The tire pressurization/sealant system of claim 3 further comprising a third conduit opposing one of the two normally aligned conduits.

5. The tire pressurization/sealant system of claim 4 wherein the point of the coned plunger operatively engages an open end of the conduit normal to the two opposing conduits.

6. The tire pressurization/sealant system of claim 1 wherein the coned plunger includes a plunger head defining a base portion below a coned portion.

7. The tire pressurization/sealant system of claim 6 wherein the base portion defines sidewalls and the sidewalls are at least as tall as the diameter of one of the conduits.

8. A tire pressurization/sealant system comprising:
a first fluid source;
a plunger valve assembly;
a first conduit extending from the first fluid source to the plunger valve assembly; and
a tire pressurizing hose extending from the plunger valve assembly.

9. The tire pressurization/sealant system of claim 8 wherein the first fluid source is one of air, sealant, or aqueous solution.

10. The tire pressurization/sealant system of claim 9 wherein a pressure differential is provided between the first fluid and the plunger assembly.

11. The tire pressurization/sealant system of claim 9 wherein the first fluid source can be alternated between air, sealant, and/or aqueous solution.

12. The tire pressurization/sealant system of claim 8 further comprising a second fluid source and a second conduit extending from the second fluid source to the plunger valve assembly

13. The tire pressurization/sealant system of claim 12 wherein the second fluid source is one of air, sealant, or aqueous solution.

14. The tire pressurization/sealant system of claim 13 wherein the first fluid source is one of air, sealant, and/or aqueous solution and the second fluid source is different from the first fluid source.

15. A method for providing sealant to a tire via a tire pressurizing hose and cleaning out the tire pressurizing hose comprising:
providing tire sealant to a tire via a tire pressurizing hose through a plunger valve assembly; and
reconfiguring the plunger valve assembly to provide an aqueous solution through the hose to clean out the valve assembly and the hose.

16. The method of claim 15 further comprising operatively connecting the tire pressurizing hose to a tire.

17. The method of claim 16 after providing the sealant, disconnecting the tire pressurizing hose from the tire.

18. The method of claim 15 wherein the plunger valve assembly receives pressurized sealant during the providing the tire sealant.

19. The method of claim 15 wherein the plunger valve assembly receives pressurized aqueous solution during the providing the aqueous solution.

20. The method of claim 15 wherein the aqueous solution is a tire sealant removal solution.
